(19) United States
(12) Patent Application Publication
(10) Pub. No.: US 2006/0078311 A1
(43) Pub. Date: Apr. 13, 2006

(54) System for concurrently recording a video sequence and location information

(76) Inventor: Robert W. Bales, Portland, OR (US)

Correspondence Address: SMITH-HILL AND BEDELL, P.C., 16100 NW CORNELL ROAD, SUITE 220, BEAVERTON, OR, 97006, US

(21) Appl. No.: 10/964,168

(22) Filed: Oct. 12, 2004

(51) Int. Cl. H04N 5/76; H04N 5/225

(52) U.S. Cl. 386/117

(57) ABSTRACT

A video camera is used to record a picture sequence on a recording medium. A related geographic location signal provided by a GPS receiver is recorded as audio data on the recording medium concurrently with the picture sequence.

### BACKGROUND OF THE INVENTION

This invention relates to a system for concurrently recording a video sequence and location information.

A conventional GPS receiver may have an RS-232 serial port at which it provides output data encoded as a sequence of ASCII text characters in the format specified by the National Marine Electronics Association (NMEA) standard NMEA 0183. Each character is composed of eight bits, preceded by a start bit (always 0) and followed by a stop bit (always 1). For example, the bit sequence 0001001001, shown by waveform A in FIG. 1, represents the character “ [symbol] ” The characters are provided at a rate of 480 characters per second. Since each character requires ten bits, the data rate at which the output data is provided to the RS-232 port is 4800 baud.

The GPS data is provided by the receiver in blocks or sentences. Each block starts with the character “ [symbol] .” Following the character “ [symbol] ” there is a sequence of letters designating the type of data, followed by the data itself and a checksum. For example, the letters GPRMC are associated with geographic location data (latitude and longitude) and time.

A software application running on a personal computer may display a form that defines a window. The application may display a so-called ActiveX control within the window. The display may be composed of a background window and a foreground window. The foreground window typically is transparent for most of the area of the window but may include an opaque element, such as a cursor. This allows the user to view the cursor or other foreground feature as an overlay against the background window, in this case, the ActiveX control display. One ActiveX control that is commercially available is the Microsoft MapPoint ActiveX control.

Software is also available which can be used in conjunction with a GPS receiver connected to a serial port of the computer to select a geographic domain that includes the location specified by the geographic location data provided by the GPS receiver and to display a map of that geographic domain in the display window concurrently with an icon indicating the location on the map of the position specified by the geographic location data.

A conventional consumer camcorder records image data as a sequence of images on magnetic tape. The camcorder includes an internal microphone that acquires a two-channel (stereo) audio signal and is connected to a recording circuit that records the audio signal on the sound track of the tape. Some camcorders include additional inputs such that four audio channels may be recorded. It will be understood by those skilled in the art that in more recent camcorders, such as those that employ the DV standard, digital audio data and digital video data are recorded in interspersed fashion rather than in distinct physical regions of the tape. Nevertheless, it is convenient to refer to the audio data as being recorded on the sound track of the tape. A consumer camcorder is typically capable of recording audio signals at frequencies up to 9 kHz. The typical camcorder has an audio-in receptacle for receiving a plug that is connected to an external microphone. When a standard microphone plug is plugged into the audio-in receptacle of the camcorder, the internal microphone is disconnected from the recording circuit and the signal received by way of the audio-in receptacle is recorded on the sound track.

There is currently commercially available a professional camcorder that can be used in conjunction with an optional GPS device to record camera location coordinates as meta data identifying the video. A knowledgeable user may transfer this data to a computer and determine how it is to be used. Professional camcorders are generally used for activities such as electronic news gathering for commercial broadcast, and sound quality is very important in these applications. Conversely, the user of a consumer camcorder may often consider image quality more important than sound quality.

Conventional video camcorders have mechanisms for recording limited information, such as time and date, in association with an image. At present, the user of a consumer camcorder who wishes to record the location at which a particular sequence of images was shot must use a notebook or other means that requires the user not only to remember to make a record but also to be careful that the record be accurate.

### SUMMARY OF THE INVENTION

In accordance with a first aspect of the invention there is provided a method of using a video camera that records picture information and audio data on a recording medium, said method comprising employing the camera to record a picture sequence on the recording medium, acquiring a related geographic location signal from a GPS receiver, and recording the related geographic location signal as audio data on the recording medium concurrently with the picture sequence.

In accordance with a second aspect of the invention there is provided a system for concurrently recording picture information and location information comprising a GPS receiver for providing a geographic location signal, a video camera for recording picture information and audio data on a recording medium, the camera including an audio input means for receiving a signal and an audio recording circuit for recording a signal received at the audio input means as audio data on the recording medium, and a connection means for passing the geographic location signal to the audio recording circuit of the camera.

In accordance with a third aspect of the invention there is provided a playback system for playback of a video recording medium on which a geographic location signal provided by a GPS receiver has been recorded as audio data, comprising an audio reading means for reading the audio data from the video recording medium, and a decoding means for recovering geographic location data from the audio data.

### BRIEF DESCRIPTION OF THE DRAWINGS

For a better understanding of the invention, and to show how the same may be carried into effect, reference will now be made, by way of example, to the accompanying drawings, in which

FIG. 1 is a graph illustrating waveforms that might be useful in understanding the invention,

FIG. 2 is a schematic block diagram of a system for recording location information on the sound track of a video tape,

FIG. 3 is a schematic block diagram of a first system for playback of a video tape having location information recorded on the sound track,

FIG. 4 is a schematic block diagram of a second system for playback of a video tape having location information recorded on the sound track,

FIG. 5 illustrates a screen display that might be provided by the system shown in FIG. 4,

FIG. 6 is a schematic block diagram of a third system for playback of a video tape having location information recorded on the sound track, and

FIG. 7 illustrates a screen display that might be provided by the system shown in FIG. 6.

### DETAILED DESCRIPTION

FIG. 2 illustrates schematically a system for recording GPS data on the sound track of a camcorder video tape. FIG. 2 illustrates a standard GPS receiver 10 and a camcorder or video camera 14 having an audio recording circuit 16 and a video recording circuit 18 for recording on videotape in a cassette 20. The camcorder 14, which may be a camcorder marketed to consumer or professional users, employs the so-called DV recording format, in which the audio information is sampled at a rate of 32 ks/second or 48 ks/second (depending on the setting of the camcorder) and quantized to 12 or 16 bits (again depending upon the camcorder setting) and is recorded digitally on the sound track of the video tape. The GPS receiver provides a serial data signal at an RS-232 serial port 22. A signal conditioning circuit 24 receives the serial data signal and conditions the signal for recording on the sound track of the video tape.

The signal conditioning circuit is connected to a standard audio input plug 26 which plugs into the external microphone receptacle or a line-level input receptacle 28 of the camcorder 14. Since the data rate is only 4800 baud, the serial port signal can be satisfactorily recorded by a recording circuit designed to record signals at frequencies up to 9 kHz.

Referring to FIG. 3, during playback of the video tape, the video may be displayed on a suitable monitor 30. The digital output of the playback device 32, which may be a camcorder or VCR, is connected to a personal computer 36 by an IEEE-1394 interface.

The playback device 32 reads the digital signal from the video tape and the IEEE 1394 driver in the playback device supplies the digital signal to an IEEE 1394 receiver 38 in the computer 36. The IEEE 1394 receiver passes the digital data, containing both video and audio, to the A/V splitter 39, which separates the video from the audio data and provides a sequence of audio sample values to a bitstream recovery procedure 40. The audio data will consist of samples for two or more channels. Only samples corresponding to the channel used for GPS data will be passed to the bitstream recovery procedure. The video data is not further used by the personal computer 36. Let us assume for the purpose of the following discussion that the sampling rate is 48 ks/sec. so that each bit of each character in the serial data signal is represented by ten sample values.

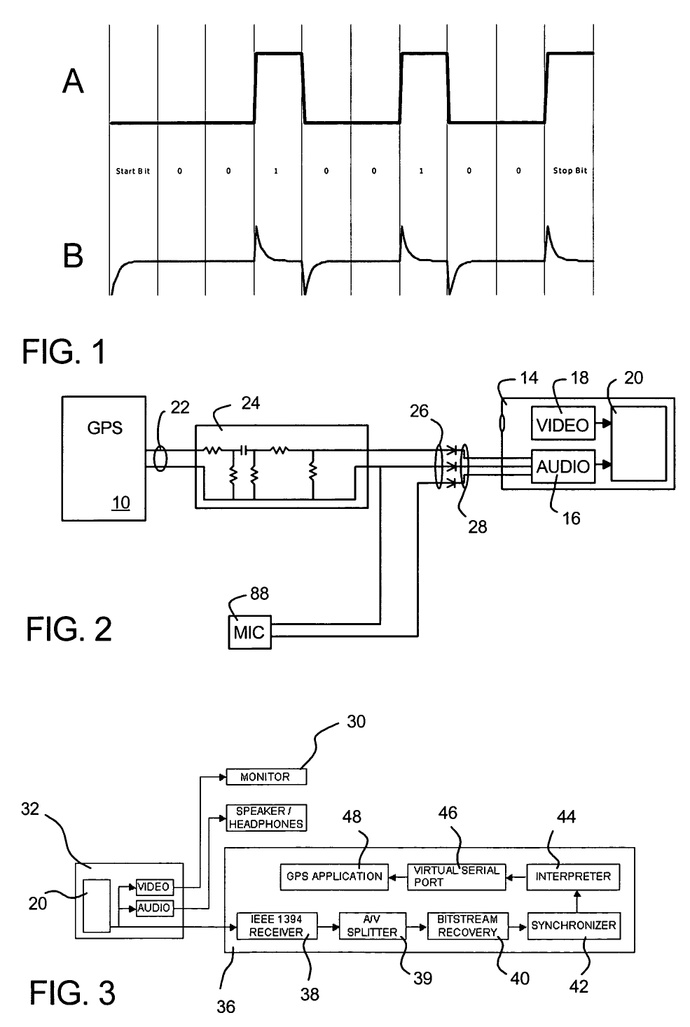

It will be understood by those skilled in the art that the bitstream can be recovered more reliably from edge information than from level information. Therefore, referring again to FIG. 2, the signal conditioning circuit 24 differentiates the signal received by way of the RS-232 port so that only the edges of the bits are recorded on the tape. A transition from a bit value 0 to a bit value 1 results in a positive peak in the signal that is supplied to the camcorder, a transition from a bit value 1 to a bit value 0 results in a negative peak, and two consecutive bits of the same level result in no transition. See waveform B in FIG. 1. Depending upon the internal circuitry of the camcorder, the waveform may be inverted before being recorded. Therefore, given waveform A, the signal recorded may be either waveform B or the inverse of waveform B, in which a transition from a bit value 0 to a bit value 1 results in a negative peak in the signal and a transition from a bit value 1 to a bit value 0 results in a positive peak. The signal conditioning circuit also attenuates the signal.

By identifying positive and negative peaks in the sequence of integer values, the bitstream recovery procedure is able to reconstruct the sequence of bits in the GPS receiver's serial data signal.

The bitstream recovery procedure 40 includes a threshold detector function (not shown) that provides an output indicating whether a sample represents a positive peak, a negative peak or a uniform signal level. Having identified, by reference to sample number, the time of occurrence of a positive or negative peak, it is then possible to calculate at what sample the next bit time, i.e. the start of the next bit, should occur. If the threshold detector function does not detect a positive or negative peak by or shortly after the expected time of occurrence of the next bit time, the bitstream recovery procedure assumes that the next bit has the same value (0 or 1) as the current bit. The sequence of bit values that is thus provided matches the bitstream provided by the GPS receiver at the serial port.

Because of the possible inversion of the audio in the camcorder, the bitstream recovery procedure has two sections, one using the audio sequence from the tape and the other the inverted sequence.

Referring to FIG. 3, the recovered GPS bitstreams from the two sections of the bitstream recovery procedure 40 are supplied to respective sections of a synchronizer procedure 42 in order to identify the boundaries of the characters. The sequence of bit values does not indicate explicitly which occurrence of a 0 is a start bit or which occurrence of a 1 is a stop bit.

Let us assume a sequence of bits b0 . . . bN. One of the bits b0-b9 must be a start bit. If bit bi (i=0 . . . 9) is the start bit, bit b(i+9) must be a stop bit and bit b(i+10) must be a start bit. Given this structure of the bit stream, it is quite easy to identify the boundaries of the characters.

In order to identify correctly the boundaries of the characters, each section of the synchronizer procedure 42 selects the first zero bit (bit bi) and assumes, rightly or wrongly, that it is a start bit and interprets the next eight bits as a character code. If the assumption is correct, the tenth bit (i.e. bit b(i+9)) should be a 1 (the stop bit associated with the assumed start bit). If the tenth bit is not a 1, we know that the start bit assumption was not correct and we discard the presumed character code and test the bit stream on the assumption that the next zero is a start bit. If the test based on the value of the tenth bit being 1 returns a positive result, the next bit should be a start bit (zero). If so, processing continues; otherwise, the synchronizer looks for the next zero bit and commences a new test based on this bit being a start bit.

If the test based on start and stop bits returns a positive result, it is still possible for the result to be invalid since the test can be satisfied by, for example, bit 4 of a first character being 0 and bit 3 of the next character being 1. Nevertheless, after a few characters, the error will be revealed and the synchronizer will search for another possible start bit. Since each character and its start and stop bits occupy only ten bits of the bitstream, the synchronizer will synchronize to the characters quite quickly. Once synchronized, the synchronizer 42 generates a valid sequence of ASCII characters. Each synchronizer section sends the sequence of ASCII characters to an interpreter procedure 44 that parses the ASCII character sequence to identify the NMEA sentences and extract a sentence containing geographic location data. If the checksum of the sentence is correct, the information is valid and can be used. Only one of the recovery paths, consisting of bitstream recovery, a synchronizer, and an interpreter, will produce valid NMEA sentences, according to whether the original audio data was or was not inverted in the camcorder.

The valid NMEA data is provided to a virtual serial port 46 of the computer. The virtual serial port appears to the operating system, and to any applications using the operating system, as if it were a hardware port, such as the common “COM 1” and “COM 2” ports. Applications which normally connect to a hardware serial port though the operating system may connect to the virtual serial port and use the geographic location data from the video tape in the same manner as if the geographic location data had been received from a GPS receiver connected to a hardware serial port at the time the video was recorded.

A GPS application 48 receives the valid NMEA data from the virtual serial port 46. The GPS application may, for example, select a geographic domain that includes the location specified by the geographic location data specified by the NMEA data and display a map of that geographic domain on the computer's monitor (not shown) or simply display the latitude and longitude of the geographic location.

A video sequence usually consists of several individual scenes, each having a length in the general range of 10-60 seconds. Between the scenes, the camcorder will be stopped and then started. In general, the bitstream after a scene change will be not be in phase with the bitstream before the scene change. Accordingly, the synchronizer procedure continuously monitors the bitstream to verify that it remains synchronized to the start and stop bits of the NMEA characters and, if necessary, resynchronizes to the NMEA characters. It is, of course, possible that the bitstream after a scene change will in fact be in phase with the bitstream before the scene change and the interpreter might then provide an NMEA sentence that appears to be valid but is in fact composed of characters from two different scenes. Usually, an error of this nature will be detected by the checksum.

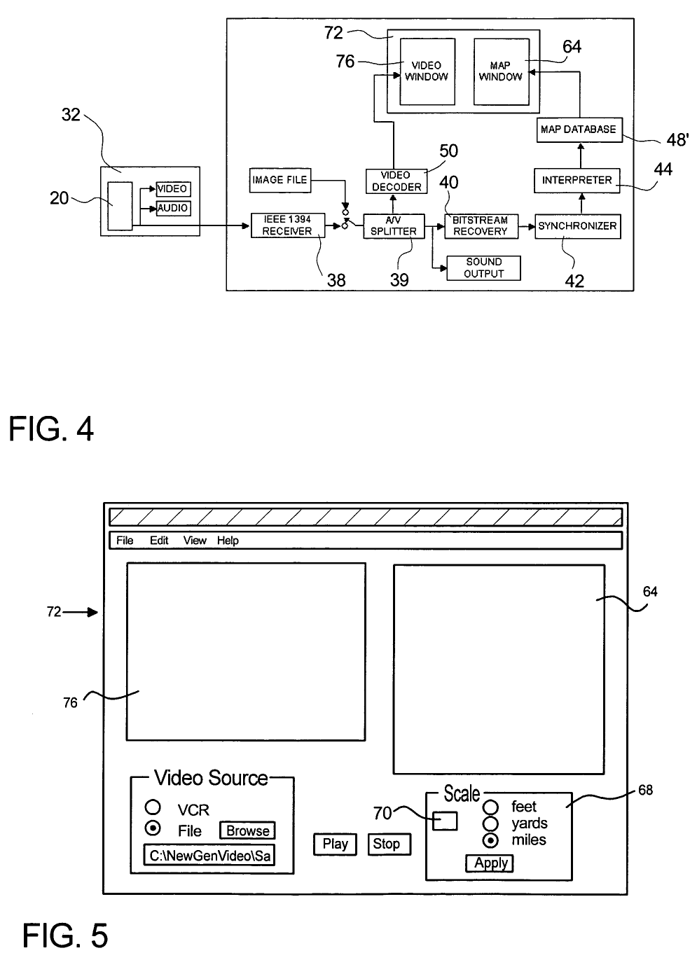

Referring to FIGS. 4 and 5, in another embodiment of the invention the A/V splitter 39 supplies the video data to a video decoder 50. FIGS. 4 and 5 also illustrate the possibility of the video image's source being an image file that has previously been saved on the computer. In either case, the image source includes data representing both the digital video signal and the digital audio signal derived from the GPS receiver's serial port signal.

The application displays a form 72 that defines a map display window 64 and a video image window 76. The video image window 76 is connected to the video decoder 50 and accordingly the window 76 displays the video sequence that was previously recorded on the video tape. The map database 48′, which may be the Microsoft MapPoint ActiveX control, is connected to the map display window 64. The displayed form contains controls, such as “Play” and “Stop,” which are similar in form and appearance to the hardware controls on a VCR. When the “Play” control is pressed (with the mouse), either the hardware playback device or data reading from the image file is started, according to which image source is selected. The digital video data is used to display the video image sequence in the video image window 76. Concurrently, the digital audio data is supplied to the bitstream recovery circuit and is processed, as described above.

Referring also to FIG. 5, the form also includes a control 68 that allows the user to select the scale at which the map is to be displayed in the map display window 64 by entering a number in the box 70, selecting whether that number should be a number of feet, yards or miles, and pressing the Apply button. For example, if the user selects 1 mile, the horizontal extent of the map that is shown in the map display window is 1 mile. It is then possible to calculate the range of latitude and longitude coordinates corresponding to the vertical and horizontal extents of the display window.

When a valid NMEA sentence containing geographic location data is recovered from the audio stream, the latitude and longitude are converted from text to numeric values and sent to the map database 48′. The database uses the geographic location data and the scale value selected by the user to display a map of a geographic domain that contains the location defined by the geographic location data.

The map database 48′ calculates the current position relative to the latitude and longitude ranges covered by the map window. The database is queried with each new geographic location to determine the corresponding location in display coordinates within the map window. If the new location is outside the map window, the map is commanded to move to a new location.

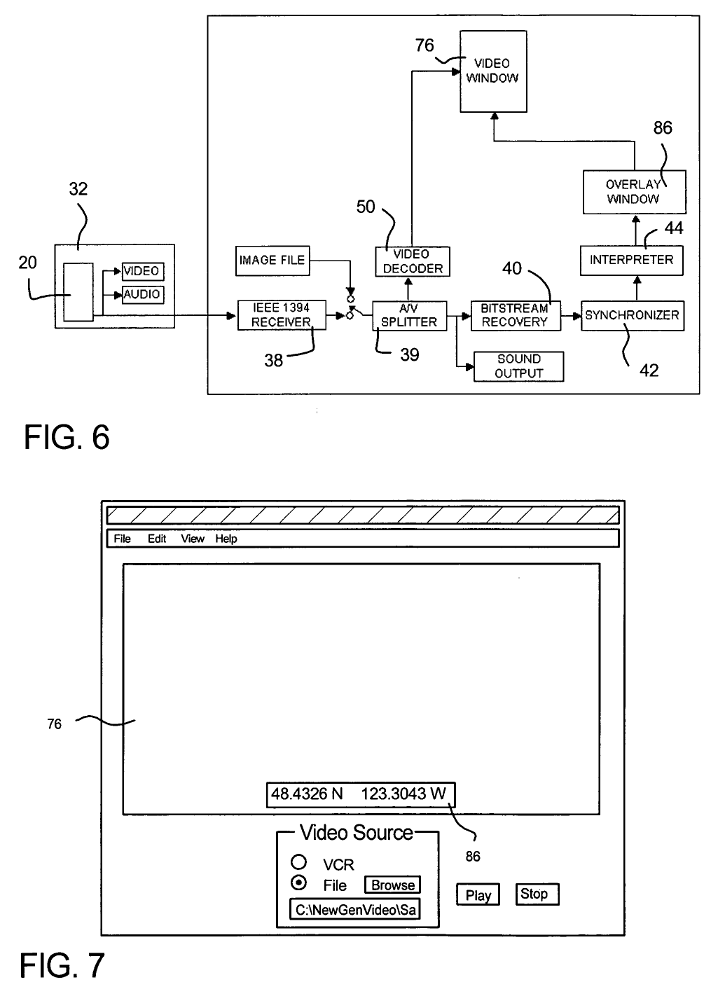

In the case of FIGS. 6 and 7, the display application does not display a map. The text coordinates (latitude and longitude) of the video sequence in the video window 76 are supplied to an overlay window, which is connected to the video window and displays these coordinates on the computer monitor in an overlay window 86 over the video sequence, which is a background layer. It will be appreciated that other information provided by the GPS receiver, such as altitude and compass bearing, may also be displayed, and that the particular items that are displayed may be user selectable.

In each of the described embodiments of the invention, the user of a camcorder, which may be a consumer camcorder, is provided with a contemporaneous record of the location at which video sequences have been shot without taking any action other than connecting the GPS receiver to the audio input receptacle of the camcorder as shown in FIG. 2. The user does not have to remember to update a log or take care that entries in the log are accurate and are properly referenced to the image sequences that have been shot with the camcorder. Also, the record is a permanent part of the tape, rather than being a separate log that could get separated from the video it describes.

Generally, plugging anything into the external audio receptacle of a camcorder disconnects the internal microphone of the camcorder from both channels of the sound track, and since the GPS data is accommodated in only one channel, the other channel is unused. Referring again to FIG. 2, a one-channel microphone 88 may be connected to the plug 26 to allow a single channel of audio to be recorded. This does not apply if the GPS data is sent to a line-level input, since there is generally a separate line input receptacle for each channel.

It will be appreciated that the invention is not restricted to the particular embodiment that has been described, and that variations may be made therein without departing from the scope of the invention as defined in the appended claims and equivalents thereof. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated.

1. A method of using a video camera that records picture information and audio data on a recording medium, said method comprising:
employing the camera to record a picture sequence on the recording medium,
acquiring a related geographic location signal from a GPS receiver, and
recording the related geographic location signal as audio data on the recording medium concurrently with the picture sequence.

2. A method according to claim 1, comprising conditioning the geographic location signal prior to recording as audio data on the recording medium.

3. A method according to claim 2, comprising differentiating and attenuating the geographic location signal prior to recording as audio data on the recording medium.

4. A method according to claim 1, wherein the GPS receiver has a serial port and the camera has an audio input, and the method comprises passing an electrical signal developed at the serial port to the audio input of the camera.

5. A method according to claim 1, further comprising displaying a video image derived from the picture information recorded on the recording medium and concurrently displaying location information derived from the audio data recorded on the recording medium.

6. A method according to claim 5, wherein the step of concurrently displaying location information comprises displaying a map of a geographic domain that includes the geographic location defined by the location information.

7. A method according to claim 5, wherein the step of concurrently displaying location information comprises displaying text characters that represent latitude and longitude values that specify the geographic location defined by the location information.

8. A method according to claim 7, wherein the geographic location signal includes latitude and longitude values encoded in a sequence of bytes and the method comprises receiving the sequence of bytes and decoding the sequence of bytes.

9. A method according to claim 5, wherein said related geographic location signal comprises a sequence of bytes and the method comprises reading audio data from the recording medium and creating a sequence of bytes that matches the sequence of bytes in said related geographic location signal.

10. A system for concurrently recording picture information and location information comprising:
a GPS receiver for providing a geographic location signal,
a video camera for recording picture information and audio data on a recording medium, the camera including an audio input means for receiving a signal and an audio recording circuit for recording a signal received at the audio input means as audio data on the recording medium, and
a connection means for passing the geographic location signal to the audio recording circuit of the camera.

11. A system according to claim 10, wherein the connection means includes a filter for conditioning the geographic location signal.

12. A playback system for playback of a video recording medium on which a geographic location signal provided by a GPS receiver has been recorded as audio data, comprising:
an audio reading means for reading the audio data from the video recording medium, and
a decoding means for recovering geographic location data from the audio data.

13. A playback system according to claim 12, wherein the geographic location signal provided by the GPS receiver comprises a sequence of bytes and the decoding means comprises a means for receiving the audio data and employing the audio data to generate the original sequence of bytes in the geographic location signal provided by the GPS receiver.

14. A playback system according to claim 12, wherein the geographic location signal provided by the GPS receiver comprises a sequence of bytes and the decoding means comprises a means for receiving the audio data and employing the audio data to generate the original sequence of bytes in the geographic location signal provided by the GPS receiver and employing the sequence of bytes to select a map of a geographic domain that includes the geographic location specified by the geographic location signal.

15. A playback system according to claim 12, wherein the geographic location signal provided by the GPS receiver comprises a sequence of bytes, the decoding means is implemented by a computer and comprises a means for receiving the audio data and employing the audio data to generate the original sequence of bytes in the geographic location signal provided by the GPS receiver, and the computer also implements a virtual serial port for receiving the sequence of bytes from the decoding means and for making the sequence of bytes available to a GPS application.

16. A playback system according to claim 12, wherein the decoding means includes a means for outputting text characters that define the geographic location.

17. A playback system according to claim 16, further comprising a video reading means for reading video information from the recording medium, a display connected to the video reading means for displaying a picture sequence represented by the video information, and an overlay means for displaying the text characters as an overlay image over the picture sequence.

18. A playback system according to claim 12, further comprising a video reading means for reading video information from the recording medium, a display connected to the video reading means for displaying a picture sequence represented by the video information, a means responsive to the geographic location data for accessing data that represent a map of a geographic domain that includes the location defined by the geographic location data, and a means for displaying the map concurrently with the picture sequence.
